(19) United States
(12) Patent Application Publication
(10) Pub. No.: US 2005/0257658 A1
(43) Pub. Date: Nov. 24, 2005

(54) Stamping and die-cutting tool with a quick mould change design

(76) Inventor: Yang-Ming Weng, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 10/986,598

(22) Filed: Nov. 13, 2004

(30) Foreign Application Priority Data
May 19, 2004 (TW) 093207783

(51) Int. Cl. B29D 22/00; B26D 5/08

(52) U.S. Cl. 83/588; 83/620; 83/646

(57) ABSTRACT

The present invention relates to a stamping and die-cutting tool with quick mould change design, which comprises: a casing; a pushing member have a pushing portion to be fixed at an extended position and a retracted position alternatively after being pressed repeatedly, the pushing member is fixed in the casing; a mould have an attractive surface and is moveably disposed in the casing in such a manner that the attractive surface is attracted to the pushing portion of the pushing member; by pressing the mould, the pushing member will be moved out of and retracted into the casing, so that the mould can be changed easily.

### BACKGROUND OF THE INVENTION

1. Field of the Invention

The present invention relates to a stamping and die-cutting tool capable of stamping or cutting out a desired pattern from a given material, and more particularly to a stamping and die-cutting tool with quick mould change design.

2. Description of the Prior Arts

With reference to FIG. 1, a conventional stamping and die-cutting tool with a mould change design includes a casing 11 on which is provided with a handle 12. The handle 12 is to be pressed by the user and will return to its original position after being pressed. In the front end of the casing 11 is disposed a mould 13, and a pushing member 14 is disposed in the case 11 and located opposite to the abutment surface 131 of the mould 13. By pulling a pulling portion 141 of the pushing member 14, a pushing portion 142 of the pushing member 14 will be caused to push the mould 13 out of the casing 11, so that the mould 13 can be replaced. However, this conventional stamping tool still has some problems:

First, during the course of changing the mould 13, the user has to hold the casing 11 with one hand while pressing the pushing member 14 with another hand, so that the mould 13 will probably fall to floor, in case that the user pull too hard, thus leading to a damage.

Second, for aesthetic reasons, the pushing member 14 is hidden inside the casing 11 without being pressed. In this case, before changing the mould 13, the user has to find out pushing member 14 and then press the pulling portion 141. This is time-consuming.

Third, the pushing member 14 is <-shaped, and the connecting portion between the pulling portion 141 and the pushing portion 142 is likely to be broken if an overgreat force is applied.

The present invention has arisen to mitigate and/or obviate the afore-described disadvantages.

### SUMMARY OF THE INVENTION

The primary objective of the present invention is to provide a stamping and die-cutting tool with quick mould change design that is capable of changing the mould easily.
a stamping and die-cutting tool with quick mould change design provided in accordance with the present invention comprises:
a casing;
a pushing member have a pushing portion to be fixed at an extended position and a retracted position alternatively after being pressed repeatedly, the pushing member is fixed in the casing;
a mould have an attractive surface and is moveably disposed in the casing in such a manner that the attractive surface is attracted to the pushing portion of the pushing member;
by pressing the mould, the pushing member will be moved out of and retracted into the casing, so that the mould can be changed easily.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a cross sectional view of a conventional stamping and die-cutting tool with quick mould change design;

FIG. 2 is an exploded view of a stamping and die-cutting tool with quick mould change design in accordance with the present invention;

FIG. 3 is a cross sectional view of a stamping and die-cutting tool with quick mould change design in accordance with the present invention;

FIG. 4 is an operational view of a stamping and die-cutting tool with quick mould change design in accordance with the present invention;

FIG. 5 is an operational view of the pushing member of the stamping and die-cutting tool with quick mould change design in accordance with the present invention;

FIG. 6 is another operational view of the pushing member of the stamping and die-cutting tool with quick mould change design in accordance with the present invention.

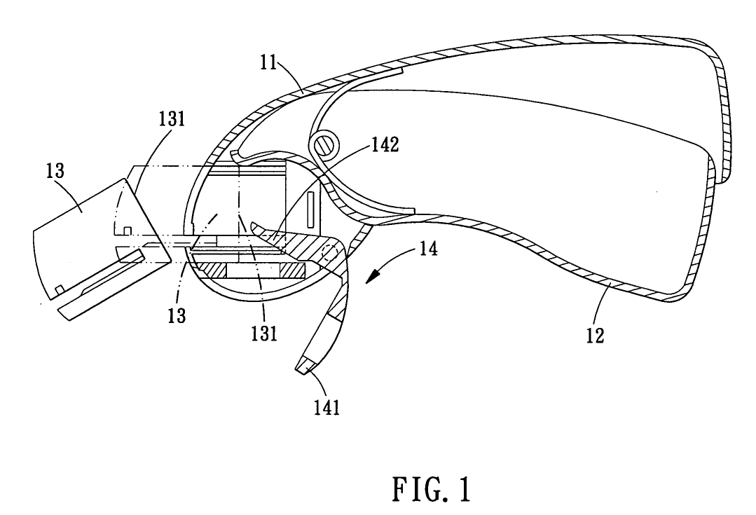

### DETAILED DESCRIPTION OF THE PREFERRED EMBODIMENT

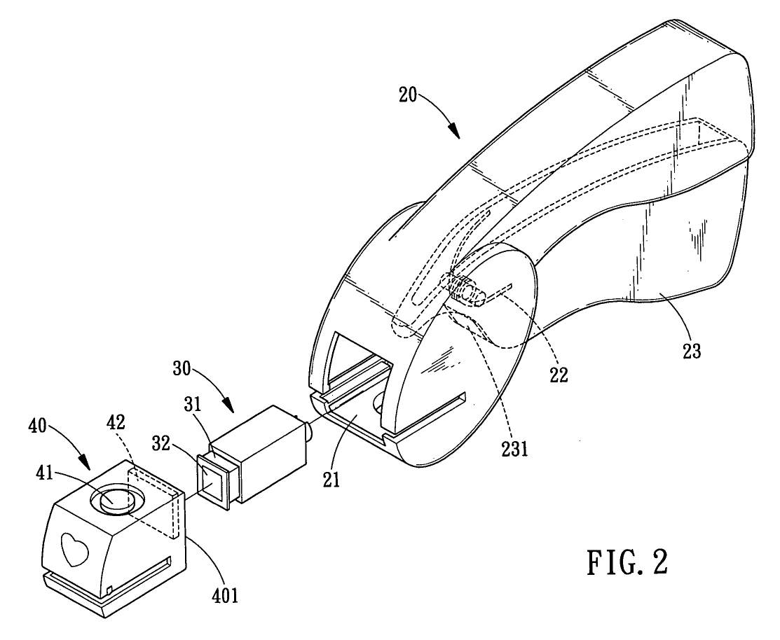

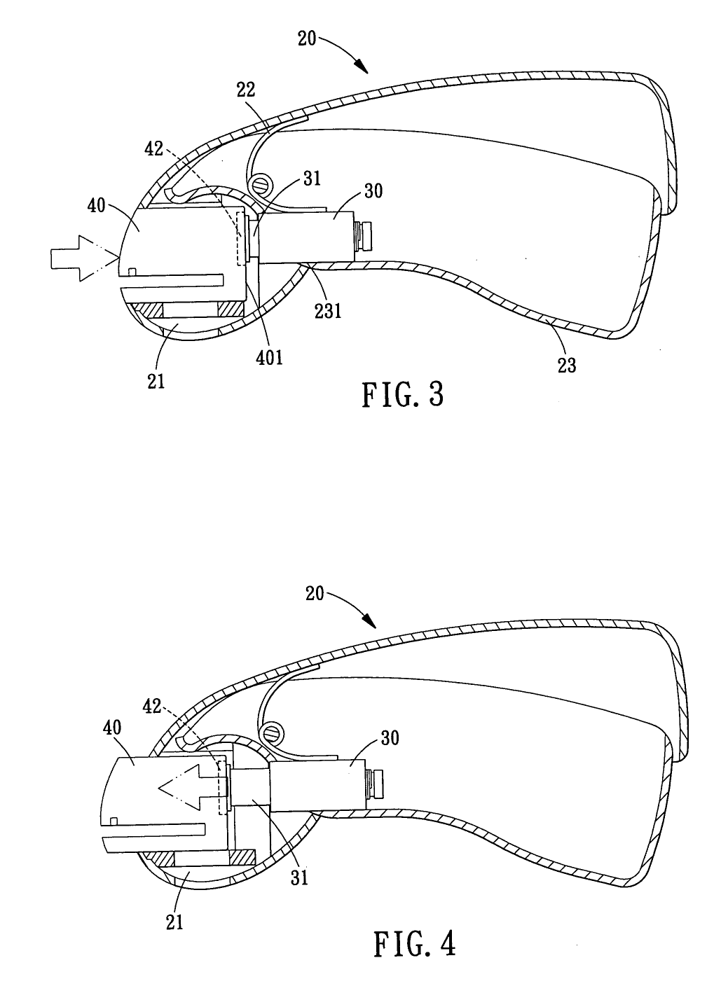

Referring to FIGS. 2 and 3, a stamping and die-cutting tool with quick mould change design is shown and comprises: a casing 20, a pushing member 30 and a mould 40.

The casing 20 is defined at the front end thereof with a chamber 21, a handle 23 is provided at the rear end of the casing 20 by using a torsion spring 22 so that the handle 23 will return to its original position after being pressed. At the front end of the handle 23 is defined a cavity 231.

The pushing member 30 includes a pushing portion 31 which can be fixed at an extended position and a retracted position alternatively after being pressed repeatedly. A magnet 32 is provided at the end of the pushing portion 31, and the pushing member 30 is fixed in the casing 20 and inserted in the cavity 231 of the handle 23.

The mould 40 is provided with a die 41 moveable in a vertical direction, under an attractive surface 401 of the mould 40 is disposed a iron member 42, and then the mould 40 is moveably disposed in the chamber 21 of the casing 20 in such a manner that the attractive surface 401 is attracted to the pushing portion 31 of the pushing member 30.

For a better understanding of the invention, its operating advantages and specific objects attained by its uses, reference should be made to FIGS. 3 and 4. When in use, the pushing portion 31 of the pushing member 30 is fixed in a retracted position, as shown in FIG. 3. When the user presses the mould 40 in a horizontal direction, since the mould 40 is attracted to the pushing member 30, the pushing portion 31 of the pushing member 30 will move to the extended position after being pressed. Thus, the mould 40 will be pushed out of the casing 20, allowing for easy replacement. After replacement, by pressing the mould 40 again in a horizontal direction, the pushing portion 31 of the pushing member 30 will move back to the retracted position, and the mould 40 will be moved by the pushing portion 31 into the chamber 21 again. In this way, the mould 40 can be changed easily.

The mould 40 can be prevented from falling off the casing 20, during the course of replacing, since it is magnetically attracted to the pushing member 30. Furthermore, the magnet 32 can be disposed beneath the attractive surface of the mould 40 and the iron member 42 can be fixed to the end of the pushing member 30, this alternative still allows the mould 40 to be attracted to the pushing member 30, and the still can be replaced easily.

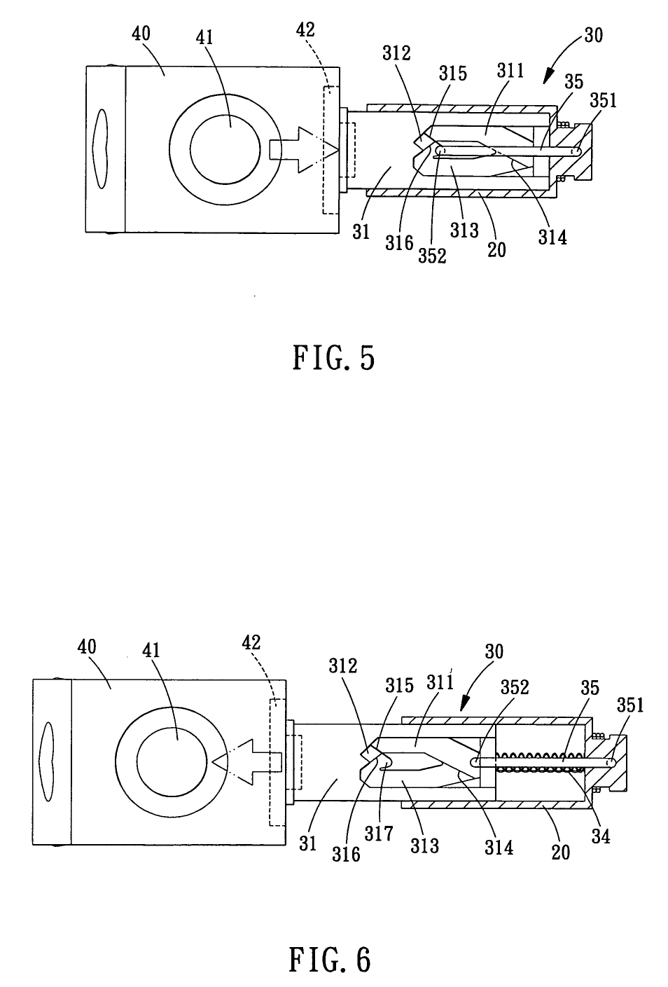

Since it is a conventional method of fixing the pushing portion 31 of the pushing member 30 at the extended position and the retracted position, this functionality is briefly illustrated with reference to FIGS. 5 and 6:

The pushing member 30 includes the pushing portion 31, a base 33, a compression spring 34 and a positioning lever 35. The pushing portion 31 is retractably disposed in the base 33, on the pushing portion 31 are formed a first annular section 311, a second annular section 312 and a third annular section 313. A first surface 314, a second surface 315 and a third surface 316 are formed at the conjunctions between the respective annular sections and located at different levels. At the third annular section 313 is formed a cavity 317, the compression spring 34 is disposed in the base 33 and located between the pushing portion 31 and the base 33. The positioning lever 35 is provided at both ends thereof with a first hook 351 and a second hook 352. The first hook 351 is fixed to the base 33 while the second hook 352 is movably disposed in the respective annular sections of the pushing portion 31.

When the second hook 352 of the positioning lever 35 is located in the first annular section 311 of the pushing portion 31 (namely, the pushing portion 31 is fixed at the extended position), by pushing the pushing portion 31 toward the base 33, the second hook 352 will move along the first surface 314 and the first annular section 311 into the second annular section 312. After releasing the pushing portion 31, the pushing portion 31 will be pushed by the compression spring 34 to move outward, meanwhile, the second hook 352 will move along the second surface 315 and the second annular section 312 into the third annular section 313, and then the second hook 352 is locked in the cavity 317. In this way, the pushing portion 31 is fixed at the retracted position. And then, by pressing the pushing portion 31 again, the second hook 352 is allowed to move along the third surface 316 to disengage the cavity 317. After releasing the pushing portion 31, the second hook 352 will be pushed by the compression spring 34 to move along the second annular section 313 into the first annular section 311, so that the pushing portion 31 is fixed at the extended portion again. In this way, the pushing member 30 can be fixed at an extended position and a retracted position alternatively after being pressed repeatedly.

While we have shown and described various embodiments in accordance with the present invention, it should be clear to those skilled in the art that further embodiments may be made without departing from the scope of the present invention.

1. A stamping and die-cutting tool with quick mould change design comprising:
a casing;
a pushing member having a pushing portion to be fixed at an extended position and a retracted position alternatively after being pressed repeatedly, the pushing member fixed in the casing;
a mould having an attractive surface and being moveably disposed in the casing in such a manner that the attractive surface is attracted to the pushing portion of the pushing member;
by pressing the mould, the pushing member will be moved out of and retracted into the casing, so that the mould is allowed to be changed easily.

2. The stamping and die-cutting tool with quick mould change design as claimed in claim 1, wherein the casing is provided with a handle which can move back to its original position after being pressed, at an end of the handle is defined a cavity provided for insertion of the pushing member.

3. The stamping and die-cutting tool with quick mould change design as claimed in claim 1, wherein a magnet is provided on a side of the pushing portion of the pushing member, and an iron member is disposed beneath the attractive surface of the mould, so that the pushing member is attracted to the mould.

4. The stamping and die-cutting tool with quick mould change design as claimed in claim 1, wherein an iron member is provided on a side of the pushing portion of the pushing member, and a magnet is disposed beneath the attractive surface of the mould, so that the pushing member is attracted to the mould.
